(19) United States
(12) Patent Application Publication
(10) Pub. No.: US 2003/0144022 A1
(43) Pub. Date: Jul. 31, 2003

(54) Mobile communications device for playing a game

(76) Inventor: Richard Hatch, Farnborough (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/059,330

(22) Filed: Jan. 31, 2002

(51) Int. Cl. H04M 1/00

(52) U.S. Cl. 455/550; 455/66

(57) ABSTRACT

A mobile communications device is used to play a game. If a user completes the game or reaches a predefined score, then game content becomes available to the user for customising their handset.

### FIELD OF THE INVENTION

The present invention relates to a mobile communications device for playing a game.

### BACKGROUND ART

Most mobile communication devices currently available support game functionality. Different types of games can be played using these device. They include games which look to test memory or reasoning and those, sometimes referred to as “video” or “arcade” games, based on reflex and dexterity.

Usually, a limited selection of games are preinstalled on the device. However, games can be installed later, for example by downloading them from a games server.

The present invention seeks to allow users to personalise their mobile communication device using game content.

### SUMMARY OF THE INVENTION

According to the present invention there is provided a method of operating a mobile communications device, the method comprising providing a game, determining whether a game objective has been achieved and, if so, providing data relating to said game for customising said device.

This has the advantage of rewarding a user who achieves a game objective and provides an incentive to play the game.

The determining whether said game objective has been achieved may comprise comprises checking whether the game has been completed or whether a score has been reached or a level completed.

The method may further comprise determining whether another game objective has been achieved and, if so, providing further data relating to said game for further customising said device.

The providing access to said data may comprise copying said data to a portion of memory or providing a pointer to said data in a portion of memory.

According to the present invention there is also provided a method of altering a user-selected idle state setting in a mobile communications device, the method comprising providing a game, determining whether a game objective has been achieved and, if so, providing data relating to said game for customising said device.

The providing of said data may comprise providing data relating to a logo for display by said mobile communications device when in an idle state.

The providing of said data may comprise providing data relating to a ring tone for use by said mobile communications device when altering a user.

According to the present invention there is also provided a computer program for carrying out the method.

According to the present invention there is also provided a method of operating a mobile communications device, the method comprising conducting a task, determining whether a task objective has been achieved and, if so, providing data relating to said task for customising said device.

The conducting of the task may comprise performing a test. The task may be performed remotely.

According to the present invention there is also provided a method of operating an electronic device for playing a game, the method comprising providing a game, determining whether a game objective has been achieved and, if so, providing data relating to said game for customising said device.

According to the present invention there is provided a mobile communications device for providing a game, said device being configured to determine whether a game objective has been achieved and, if so, to provide data relating to said game for customising said device.

The data may be stored in the device and may be comprised in game code. The data may be encrypted. The data may relate to graphics and/or music. The data may be stored at a remote server.

### BRIEF DESCRIPTION OF THE DRAWINGS

An embodiment of the present invention will now be described, by way of example, with reference to the accompanying drawings in which:

FIG. 1 shows a mobile communications device;

FIG. 2 is a schematic diagram of mobile communications circuitry;

FIG. 3 shows a display of a mobile communications device in idle state;

FIG. 4 shows a display of a mobile communications device in game mode;

FIG. 5 shows a display of a mobile communications device in idle state following customisation;

FIG. 6 illustrates a process by which a user customises their mobile communications device;

FIG. 7 shows memory within a mobile communications device;

FIG. 8 is a schematic diagram of a mobile communications device, public land mobile network and a game server; and

FIG. 9 illustrates a process by which a user obtains content with which they customise their mobile communications device.

### PREFERRED EMBODIMENT OF THE INVENTION

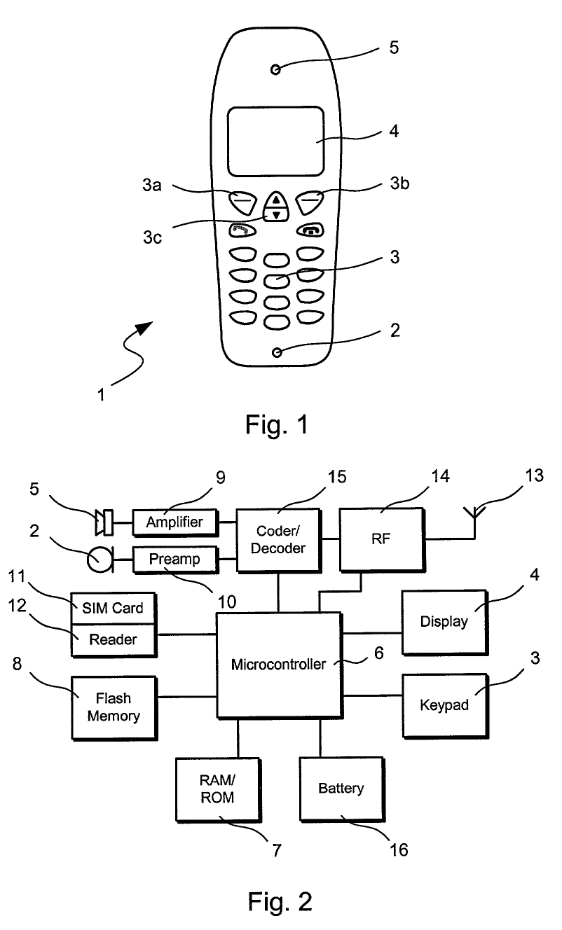

FIG. 1 shows a mobile communications device in the form of a mobile telephone handset 1, which is sometimes referred to as a cellular telephone handset. The handset 1 includes a microphone 2, keypad 3, liquid crystal display (LCD) 4 and speaker 5. The keypad 3 includes so-called soft keys 3a, 3b and a scroll key 3c which have variable functions depending on the state of the handset 1. In this case, the handset 1 conforms to a 2^{nd} generation (2g) standard, such as GSM. Nevertheless, it will be appreciated that the handset 1 may conform to a 3g standard, such as universal mobile telephone standard (UMTS).

FIG. 2 illustrates circuitry included in the handset 1. Signal processing is carried out under the control of a digital microcontroller 6 which has an associated RAM/ROM 7 and flash memory 8. Electrical analogue audio signals are produced by the microphone 2 and amplified by a pre-amplifier 9. Similarly, analogue audio signals are fed to the speaker 5 through an amplifier 10. The microcontroller 6 receives instruction signals from the keypad 3 and controls operation of the LCD 4 and flash memory 8.

Information concerning the identity of the user is held on a smart card 11 in the form of a GSM SIM card which contains the usual GSM international mobile subscriber identity and encryption Kᵢ that is used for encoding the radio transmission in a manner well known per se. The SIM card 11 is removably received in a SIM card reader 12. Radio signals are transmitted and received by means of the antenna 13 connected through a r.f. stage 14 to a codec 15 configured to process signals under the control of a microcontroller 6.

In use, for speech, the codec 15 receives analogue signals from the microphone amplifier 9, digitises them into a form suitable for transmission and feeds them to the rf stage 14 for transmission through antenna element 13 to a PLMN (not shown). Similarly, signals received from the PLMN (not shown) are fed through the antenna element 13 to be demodulated by the rf stage 14 and fed to codec 15 so as to produce analogue signals fed to amplifier 10 and speaker 5. The handset 1 is powered by a battery 16.

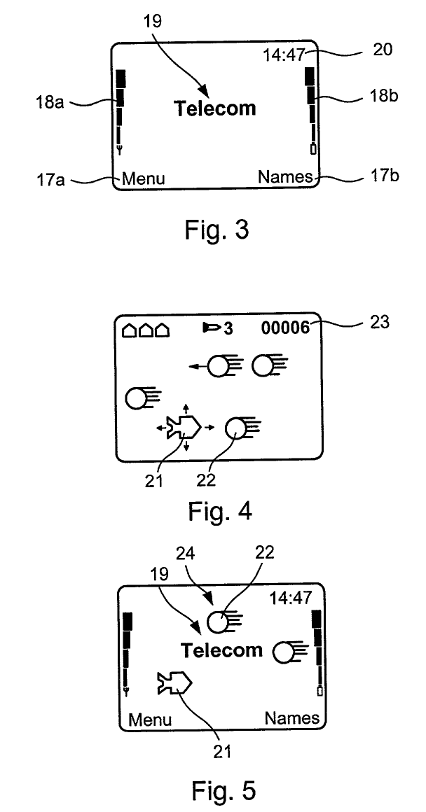

FIG. 3 shows LCD 4 when the handset 1 is in an idle state, which displays first and second legends 17a, 17b, service and battery indicators 18a, 18b, a logo 19 indicating a network provider and other icons 20, such as current time.

The logo 19 need not indicate the network provider but can be image chosen by a user to personalise the handset 1. The logo can be downloaded from a remote server. Other data, such as ring tones, can also be downloaded in a similar way.

The keypad 3 and soft keys 3a, 3b, 3c (FIG. 1) are used to supply instructions for controlling the handset 1. The result of pressing one of the soft keys 3a, 3b, 3c depends on the state of the handset 1 and is indicated by the first and second legends 17a, 17b.

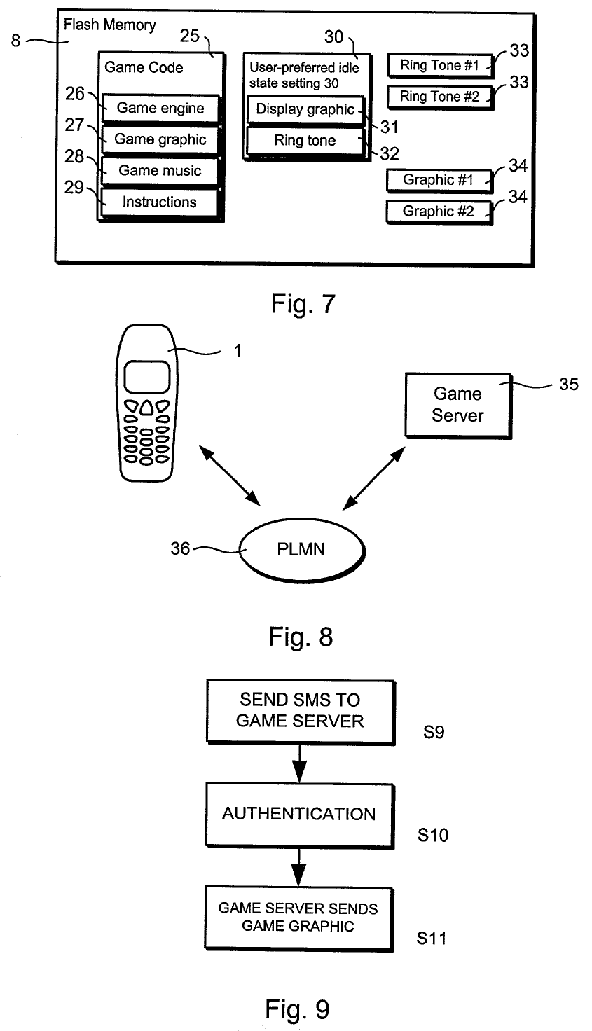

In the idle state, actuation of soft key 3a accesses a menu, while pressing soft key 3b opens an address book. The menu includes a plurality of applications, herein referred to as functions, which are executable by the handset 1 and include games. The menu is also used to access settings for handset 1a, such as ring tones. Through use of the settings function, the user can configure the handset's idle state so as to select, for example, which logo is displayed in the idle state and which ring tone is activated for use when an incoming call is received. Such settings are referred to herein as user preferred idle state settings and are stored in memory portion 30 (FIG. 7). Functions and names are selected by scrolling through the menu and address book respectively using the scroll key 3c. Alphanumeric data is entered using the keypad 3.

FIG. 4 shows LCD 4 when the handset 1 is in a game state.

The user selects to play a game called “Space Impact” in which a spacecraft 21 destroys asteroids 22 by shooting them or, when shields are up, ramming them. Weapons and shields are operated and the spacecraft 21 is manoeuvred around the display 4 using the keypad 3. A point is scored each time an asteroid is destroyed and a score is displayed 23.

According to the present invention, if the user achieves a game objective, such as completing the game or reaching a predefined score, then a reward in the form of game content becomes available to the user for customising their handset 1. In this case, the network operator logo 19 is embellished with a game graphic 24 comprising spacecraft 21 and asteroids 22 as shown in FIG. 5. Thus, the user can then show-off the handset 1 to other users.

A process by which game content becomes available to the user will now be described:

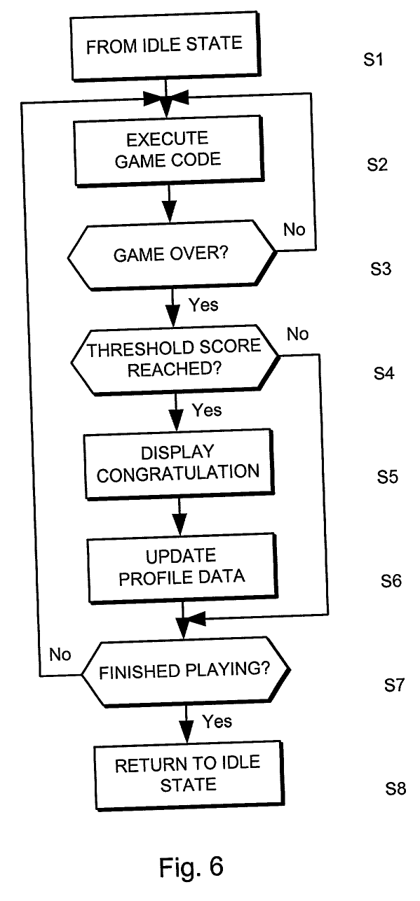

Referring to FIGS. 6 and 7, the handset 1 is in an idle state (step S1). The user elects to play a game and selects “Space Impact”. Game code 25, which is stored in flash memory 8, is retrieved and executed by microcontroller 6 (step S2).

The game code 25 includes game engine code 26 for providing the game, game graphic data 27 which is used by the game engine for providing game graphics, game music data 28 which is used by the game engine for providing music and/or sound effects and operating instructions 29 for instructing a user as to how to play the game.

The user plays the game until the game ends (step S3). The game can end for several reasons. The user may lose all their “lives”, quit or complete the game. The nicrocontroller 6 determines whether the accumulated score 23 (FIG. 4) has reached or exceeded a threshold, for example 99999 (step S4). If the threshold has been reached or exceeded, then a congratulatory message is displayed (step S5). As a reward, game content is made available to the user for updating user-preferred idle state settings 30 (step S6).

The user-preferred idle state settings 30 include a display data pointer 31 and a ring tone pointer 32. The pointers 31, 32 are directed to portions of the flash memory 8 where ring tone data 33 and display data 34 are stored and have the general structure:

struct content_pointer
{

pointer to data;
data type specifier(logo, ringtone, ...);
data length;

}

The update comprises changing the display pointer 32 to the, or part of the, game graphic data 27. This has the advantage that game graphic data 27 does not need to be copied. In this example, the pointer 32 points to portions of the game graphic data 27 concerned with the spacecraft 21 and asteroids 22.

After the user-preferred idle state settings 30 have been updated, the user can play another game (step S7) or return to idle mode (step S8).

It will be appreciated that the game content may be provided in other ways. For example, instead of updating pointers, some or all of the game graphic data 27 may be copied into the user-preferred idle state settings 30. The game graphic data 27 may be copied directly from the game code 25. Alternatively, the game graphic data 27 may be downloaded from a game server. Not only does this reduce the need for storing the game graphic data 27, but also provides an incentive for the user to register their achievement and become eligible for a prize. In the alternative embodiment, the game code 25 includes a link to the game server. Reference is made to our EP-A-1113639 which describes a system in which a game player registers with a remote server.

A method by which a user can download their reward will now be described:

FIG. 8 shows the handset 1 communicating with a game server 35 via a public land mobile network (PLMN) 36.

Referring to FIG. 9, if a user attains a game objective, a short message service (SMS) message is automatically sent to the game server 35 (step S9). The message includes the identity of the user, the identity of the game and the game objective. The message may also include security features. The server 35 authenticates the message (step S10) and, if valid, transmits the game graphic 27 as one or more SMS messages.

It will be appreciated that if the handset 1 is enabled for wireless access protocol (WAP) and the game server is a WAP server, then messages may be exchanged, optionally via a gateway, using XML.

It will be appreciated that customisation may comprise replacing the network operator logo 19 with a new logo which may include text and/or graphics. For example the operator logo “Telcom” may be replaced with a laudatory term such as “Space Impact Pro”.

It will be appreciated that different aspects of the handset 1 can be customised. For example, if the game is accompanied by music, then the reward may be in the form of music which is made available to the user as a ring tone. Thus, additionally or alternatively, the ring tone pointer 32 specifies the game music 28.

The game objective, the type of game content made available and the manner in which game content is provided may vary according to the type of game.

For example, the game may allow a plurality of users to play. In particular, the game may involve users competing with one another. If one user beats another player, the victor is provided with content from the loser. This may comprise simply copying data from the loser's handset to the victor's handset. Alternatively, data may be transferred from the loser's handset to the victor's handset and then deleted from the loser's handset. Thus, the game objective is to beat another user.

Several objectives can be set. For example, if a user achieves a score of say “1000”, they are provided with a first reward, such as a first game graphic. Then, if the user achieves a score of say “5000”, they are provided with a second reward, for example a second, different game graphic.

The game objective can be achieving a predetermined score, reaching a predetermined “level” in a game comprising a sequence of levels or scenes, reaching a target without losing a predetermined amount of “health”, acquiring a number of attributes or “power-ups” or collecting a number of items.

If the game is played against the clock, for example as in a racing game, the game objective may be to complete part of the game within a set time-limit.

If the game involves fighting, then the game objective can be to defeat all or a predefined number of opponents.

It will be appreciated that many modifications may be made to the embodiment hereinbefore described. For example, a picture, such as a digitised photograph, may be used rather than a game graphic.

Game content or pointers may be stored or downloaded in encrypted form. The encrypted content can then be decrypted as-and-when required. This prevents a user from distributing a hard-won game graphic to other users.

The device need not be a mobile communications device but a hand-held gaming device or a personal digital assistant.

Moreover, a reward scheme can be extended to other scenarios whereby if a goal is achieved, the user is rewarded by being provided with access to data for customising their device. For example, if the user completes a task, such as an on-line test or examination, then an electronic badge can be awarded to the user for display on their device.

1. A method of operating a mobile communications device, the method comprising:
providing a game;
determining whether a game objective has been achieved and, if so,
providing data relating to said game for customising said device.

2. A method according to claim 1, wherein said data is comprised in game code stored in the device.

3. A method according to claim 1, wherein the data is encrypted.

4. A method according to claim 1, wherein said data relates to graphics.

5. A method according to claim 1, wherein said data relates to music.

6. A method according to claim 1, wherein said data is downloaded from a remote server.

7. A method according to claim 1, wherein said determining whether said game objective has been achieved comprises checking whether the game has been completed.

8. A method according to claim 1, wherein said determining whether said game objective has been achieved comprises checking whether a score has been reached.

9. A method according to claim 1, wherein said determining whether said game objective has been achieved comprises checking whether a level has been completed.

10. A method according to claim 1, further comprising determining whether another game objective has been achieved and, if so, providing further data relating to said game for further customising said device.

11. A method according to claim 1, wherein said providing said data comprises copying said data to a portion of memory.

12. A method according to claim 1, wherein said providing said data comprises providing a pointer to said data in a portion of memory.

13. A method of altering a user-selected idle state setting in a mobile communications device, the method comprising:
providing a game;
determining whether a game objective has been achieved and, if so,
providing data relating to said game for customising said device.

14. A method according to claim 13, wherein said providing said data comprises providing data relating to a logo for display by said mobile communications device when in an idle state.

15. A method according to claim 13, wherein said providing said data comprises providing data relating to a ring tone for use by said mobile communications device when altering a user.

16. A computer program for carrying out the method of claim 1.

17. A method of operating a mobile communications device, the method comprising:
conducting a task;
determining whether a task objective has been achieved and, if so,
providing access to data relating to said task for customising said device.

18. A method according to claim 17, wherein said conducting of said task comprises performing a test.

19. A method according to claim 17, wherein said conducting of said task comprises performing task remotely.

20. A method of operating an electronic device for playing a game, the method comprising:
providing a game;
determining whether a game objective has been achieved and, if so,
providing data relating to said game for customising said device.

21. A mobile communications device for providing a game, said device being configured to determine whether a game objective has been achieved and, if so, to provide data relating to said game for customising said device.

22. A device according to claim 21, wherein said data is stored as game code in the device.

23. A device according to claim 21, wherein the data is encrypted.

24. A device according to claim 21, wherein said data relates to graphics.

25. A device according to claim 21, wherein said data relates to music.

26. A device according to claim 21, wherein said data is downloaded from a remote server.
